(19) United States
(12) Patent Application Publication
(10) Pub. No.: US 2026/0337002 A1
(43) Pub. Date: Oct. 29, 2026

(54) KEG COUPLER WITH SENSOR FOR A BEVERAGE KEG

(71) Applicants: DSI MICRO MATIC GMBH, Hamm (DE); VINSERVICE MICRO MATIC S.R.L., Zanica (BG) (IT)

(72) Inventors: Mirco WOLTER, Welver (DE); Stefan SUELTROP, Erwitte (DE); Philipp SOMMER, Eickelborn (DE)

(21) Appl. No.: 19/110,047

(22) PCT Filed: Sep. 4, 2023
(86) PCT No.: PCT/DE2023/100642

§ 371 Date: Mar. 7, 2025

(30) Foreign Application Priority Data
Sep. 8, 2022 (DE) 10 2022 122 874.6

(51) Int. Cl. B67D 1/08; G01F 1/34; G01F 1/58; G01F 15/063

(52) U.S. Cl. CPC B67D 1/0841; G01F 1/34; G01F 1/58; G01F 15/063

(57) ABSTRACT

Keg-coupler arrangement for connection to a beverage keg, wherein a keg coupler is provided and is able to be placed on a beverage keg and wherein the keg coupler includes a sensor for determining the through-flow and/or a pressure sensor and/or an antenna for reading out data.

### RELATED APPLICATIONS

The present application is a National Phase of International Application Number PCT/DE 2023/100642, filed Sep. 4, 2023, and claims priority of German Application Number 10 2022 122 874.6 filed Sep. 8, 2022.

### FIELD

The present disclosure relates to a keg coupler arrangement for connection to a beverage keg.

The present disclosure also relates to a method for determining the filling state of a beverage keg.

### BACKGROUND

Beverages are provided in beverage kegs, for example, in catering establishments. Common beverage keg sizes are 10 liter, 20, 25, 30 liter, but also 50 liter beverage kegs are used. The beverage kegs are delivered by a delivery logistics company and are usually stored in a region away from the dispensing room or dispenser that is not visible. This region must usually also be refrigerated so that the beverage is able to be served chilled. Beverage kegs are often stored in a beverages cellar.

There is a need to know the fill level of each beverage keg. This is the case when different kegs including different beverages are connected to a dispensing system.

This knowledge is necessary in three respects. At peak times, a keg change is able to take several minutes, which time a single pub owner, a single person operating a dispensing system, is not able to eliminate.

A second need is to know the respective fill level in order to be able to order the quantities of beverages required for the next few days or weeks in an ordering process.

A third possibility is to use the respective fill level tables to ultimately log how high the respective withdrawal quantities from a respective beverage keg were over a respective period of time.

Various inline measuring systems are described, for example a measuring arrangement is described in DE 20 207 334 U1. This uses a flow meter that enables the meter reading to be read or reset in a control unit and the quantity of beverage dispensed to be read for specific periods of time. The disadvantage here is that such a through-flow sensor is operated via an impeller, for example. The impeller engages directly in the beverage line. However, the beverage lines must be cleaned regularly, whereby so-called cleaning beads are also used. Measuring systems that engage in the beverage line are therefore disadvantageous and require separate cleaning.

### SUMMARY

The object of the present disclosure is therefore to provide an option that is as low-maintenance and error-free as possible in order to enable fill level monitoring and content indication of the tapped or tapped beverage kegs with minimal use of measuring technology.

The aforementioned object is achieved in accordance with the disclosure in the arrangement for detecting the through-flow and/or the filling state of a beverage keg.

The arrangement for detecting the through-flow and/or the filling state of a beverage keg has at least one keg coupler and a beverage keg. The keg coupler is connected or attached to the beverage keg. A sensor is assigned to the keg coupler, wherein the sensor detects at least the “through-flow” or “no through-flow” state.

The sensor itself is either integrated directly into the keg coupler or attached to the keg coupler.

According to the disclosure, sensor detects the “through-flow” or “no through-flow” state. With the aid of a stored database, which includes either of an algorithm and/or a stored tableau, a conclusion is able to be drawn as to the quantity of beverage that has flowed through the keg coupler or the line based on the time during which the through-flow is detected. This in turn is able to be used to calculate the remaining fill level of the beverage keg. For this purpose, the through-flow, e.g. in liters per minute, is stored once in the system at each measuring/dispensing point. This is done by gauging/measuring by the system operator, e.g. by measuring the time during the removal of a specific and known quantity of beverage. Alternatively, a learning program is conceivable via the electronics software in such a way that the times of all dispensing processes are added up after the start and the operator is able to then simply enter the total quantity dispensed. This in turn calculates the through-flow in liters per minute. With fixed control variables, this is usually also constant for each beverage line/installation. The through-flow only needs to be recalculated if the operator makes changes to the installation (e.g. the delivery pressure or the compensator on the tap). This is also able to be done by adding up all the times for the complete removal of an entire keg. As the operator selects the keg change in the software anyway by selecting the newly connected volume, this is also able to be done semi-automatically. Alternatively, the volume of the tapped beverage is entered in the WebApp for the last recorded measurement for calibration purposes.

If, for example, a through-flow of 2.5 l/min is stored in the system and the dispensing process takes 12 seconds, a volume of 0.5 liters has been removed is able to be calculated, which is subtracted from the total fill level of the keg.

The present disclosure has many advantages over variants. First of all, only minimal use of sensor technology is required, which is therefore inexpensive, simple and not susceptible to faults. Since the data is recorded and processed, the data is stored in an external server or in a cloud and is able to therefor be retrieved. The operator of the dispensing system is able to call up the individual fill level of one or more beverage kegs at any time, so that they are forewarned when a keg needs to be changed. A forecast is able to also be created for the ordering of beverage kegs required in the future, as the withdrawal quantities are logged over time.

In at least one embodiment, the sensor is integrated directly into the keg coupler. The sensor is designed, for example, as a Reed sensor or Reed switch or Reed contact and/or capacitive sensor and/or inductive sensor. A keg coupler plunger is located in the keg coupler. A non-return device is usually located inside the keg coupler plunger. This non-return device is designed, for example, as a magnetic rod or ball, for example, made of a metallic material. This is able to therefor be used to switch a magnetic contact and thus detect the “through-flow” or “no through-flow” state.

In terms of the disclosure, a first sensor is thus designed in such a way that a signal body, for example, as a magnetic rod or ball, but in other embodiments, is integrated into the beverage line. This signal body is moved into a different position when the beverage flows through, for example the signal body is raised in relation to the vertical direction. The signal body moves into the position of a sensor, for example, a Reed sensor, which thus detects the “through-flow” state of beverages or fluid in the beverage line. The signal body is able to be cleaned together with the keg coupler or simply removed for cleaning and then reinserted. Furthermore, such backflow preventers are known on the keg couplers.

In at least one embodiment, the keg coupler itself is able to be made of a plastic material. Such a keg coupler is described in EP 2 730 537 A2, the entire disclosure of which is included here.

It is now possible in some applications that when the keg coupler is knocked off, for example when changing a keg, the keg coupler is not stored vertically but horizontally. This is able to inadvertently trigger the “through-flow” contact. To avoid this, a second sensor is installed to detect that the keg coupler is correctly positioned and locked on the keg. This is able to be done, for example, by a second sensor that detects that the keg coupler lock is lowered and thus recognizes that the keg coupler is attached to the keg. This is also able to be done via a Reed contact. Only when the sensor detects that the keg coupler is attached to the keg does the actual first sensor also detect the “through-flow” status.

Furthermore, an inductive or capacitive sensor is conceivable, arranged in the keg coupler in such a way to detect the metal fitting of the beverage keg as soon as the keg coupler is attached. In at least one embodiment, the through-flow signal from the keg coupler is validated in the electronics or in the WebApp with the flow signal from the dispensing tap.

Additionally or alternatively, a pressure sensor is provided in the keg coupler. The pressure sensor and/or capacitive sensor and/or inductive sensor is designed, for example, as a plug-in sensor. The pressure sensor is thus sealed fluid-tight and/or gas-tight with an O-ring, for example. Due to the plug-in connection, the wired sensor is able to be rotated completely around its own axis.

In at least one embodiment, a through-flow is able to be determined using two pressure sensors connected in series in the axial direction according to the Venturi principle.

The pressure sensor is able to arranged in the keg coupler, in the gas output. To determine a through-flow, two pressure sensors are able to be arranged in series in the gas line. If pressurizing gas is introduced into the gas, this automatically means that extraction is taking place elsewhere. However, in the case of a flow meter formed by two pressure sensors, these are also able to be arranged in the beverage line of the keg coupler.

An electronic unit is assigned to the keg coupler or arranged directly on the keg coupler or integrated into the keg coupler. In at least one embodiment, if the keg coupler is made of a plastic material, the electronic circuit board is able to be arranged directly on the keg coupler. The pressure sensor and also the Reed sensor is able to be wired directly to the electronic unit. The electronic unit is able to either be connected to a higher-level evaluation unit via a cable connection. The electronic unit could also communicate with a higher-level evaluation unit via wireless communication.

In a further embodiment, the keg coupler has an antenna for reading out information. This is integrated on the base or foot of the keg coupler. In at least one embodiment, this antenna is designed as an NFC antenna or RFID in any frequency range, thus, information that is present on a keg or, a fitting of a keg and here again on a data carrier in a fitting of a keg is able to be read out. For example, data on the filling date, contents and also the type of beverage in the keg is able to be stored on such a data carrier of the fitting, which in turn is designed as an NFC or RFID in any frequency range. This data could then be read by the antenna of the keg coupler and transmitted to the electronic unit and in turn transmitted to a higher-level evaluation unit. The electronic unit and the antenna are able to read and process various NFC standards, such as ISO 14443 and ISO 15693.

The system is designed in such a way that an electronic unit or an electronic evaluation system is present. This is connected by cable to the sensors in the keg couplers. The sensors in the keg couplers then send the signal “through-flow” or “no through-flow” to the electronic evaluation unit. The electronic evaluation unit is able to calculate the through-flow directly, based on the time window in which the sensor reports “through-flow”. If necessary, an additional temperature sensor in the dispensing tap is able to be used to prevent incorrect measurement when the keg coupler is horizontal so that the through-flow measurement is validated by measuring the temperature drop when the beverage is flowing through. The same is able to be provided by a pressure sensor on the so-called gas pressure reducer of the dispensing system, in that the expected pressure drop validates the measurement of the through-flow. However, the electronic evaluation unit is also able to only record the raw data.

The raw data and/or the calculated through-flows are then forwarded to an external database. In at least one embodiment, this is a cloud. The required data is able to be retrieved from the cloud, for example via a mobile device, for example, a tablet or smartphone. This is able to be located on the host's premises or in the vicinity of the dispensing system so that the operator of the dispensing system is informed about the current fill level of a beverage keg. However, the data is also able to be forwarded to a central evaluation point in the case of a larger hospitality chain with several branches at different locations or similar, so that a central ordering process is able to be carried out from here. Furthermore, the data collected is very helpful for marketing purposes of the breweries, for example, because which brands are served well or poorly at which locations and at which times is able to be seen.

In at least one embodiment of the present disclosure, an algorithm and/or data table or data matrix is able to be stored in the evaluation unit. The “through-flow” or “no through-flow” signal and the respective time window is able to be readjusted if the measured values deviate from the actual values. This is able to be the case, for example, if an existing dispensing infrastructure allows a higher or lower through-flow, so that a respective readjustment is necessary.

In at least one embodiment, the system is also able to be designed to be self-learning. By specifying in the data matrix or entering the respective filling quantity of a beverage keg, a self-learning process is able to then take place so that, for example, when any keg is connected, the through-flow is determined by recording and adding up all through-flow times, as the system assumes that the keg is almost completely empty when the keg is changed and then correlates the measured dispensing value of the beverage quantity with the actual keg change, i.e. the used keg.

The sensors of the keg couplers are connected to the electronic evaluation unit, for example, by cable. However, wireless data transmission is also possible. However, a wired connection makes possible to connect the electronic evaluation unit centrally to a permanent power supply, for example an existing power grid. This in turn supplies the sensors in the keg couplers with energy. The sensors, for example, the NFC antenna, do not have to be connected to the electronic unit by cable, but is also able to be connected to the electronic unit by means of a pluggable or detachable connection (pin and socket).

Furthermore, the cable connection from the electronics unit to the evaluation unit (gateway) is able to be designed as an integral part of the electronics unit by means of a cable, but the electronics unit has a commercially available plug connection for data transmission so that any length of cable is able to be connected.

The data from the evaluation unit is able to in turn be transmitted wirelessly, for example via a WIFI connection or a GSM connection, so that no data line to another external evaluation unit or the cloud is required. A wired Internet connection (Ethernet) is also conceivable.

The present disclosure thus also relates to a method for operating the arrangement described above. In at least one embodiment, the method is able to be used to determine the through-flow and/or the fill level of the beverage keg.

For this purpose, the method is operated in such a way that the sensor system described above is used to detect whether a beverage is being removed from a respective beverage keg, i.e. whether “through-flow” or “no through-flow” has been established. A stored database, whereby the database is able to be an algorithm or a database tableau, is used to calculate the withdrawal quantity from the beverage keg based on the time window for which the sensor issues a message that there is a through-flow. This in turn is able to be used to determine or calculate the remaining fill level of the beverage keg.

### BRIEF DESCRIPTION OF THE DRAWINGS

Further advantages, features and aspects of the present disclosure are the subject of the following description. Various embodiments are shown in schematic figures. These serve to facilitate understanding of the disclosure. In:

FIG. 1 shows a simplified representation of the arrangement and the method for operating according to at least one embodiment,

FIGS. 2 and 3 show a keg coupler with an integrated sensor which signals “through-flow” according to FIG. 2 and which signals “no through-flow” according to FIG. 3 according to at least one embodiment,

FIG. 4 shows a keg coupler with pressure sensor according to at least one embodiment,

FIG. 5 shows a keg coupler with gas adapter, attached via spring tabs according to at least one embodiment,

FIG. 6 shows a pressure sensor, attached via latching hooks according to at least one embodiment,

FIG. 7A and FIG. 7B show a keg coupler with an antenna for reading out data according to at least one embodiment,

FIG. 8A and FIG. 8B show an alternative design variant of the antenna according to at least one embodiment, and

FIG. 9A and FIG. 9B show a further alternative design variant of the antenna according to at least one embodiment.

### DETAILED DESCRIPTION

In the figures, the same reference numerals are used for identical or similar components, even if a repeated description is omitted for reasons of simplification.

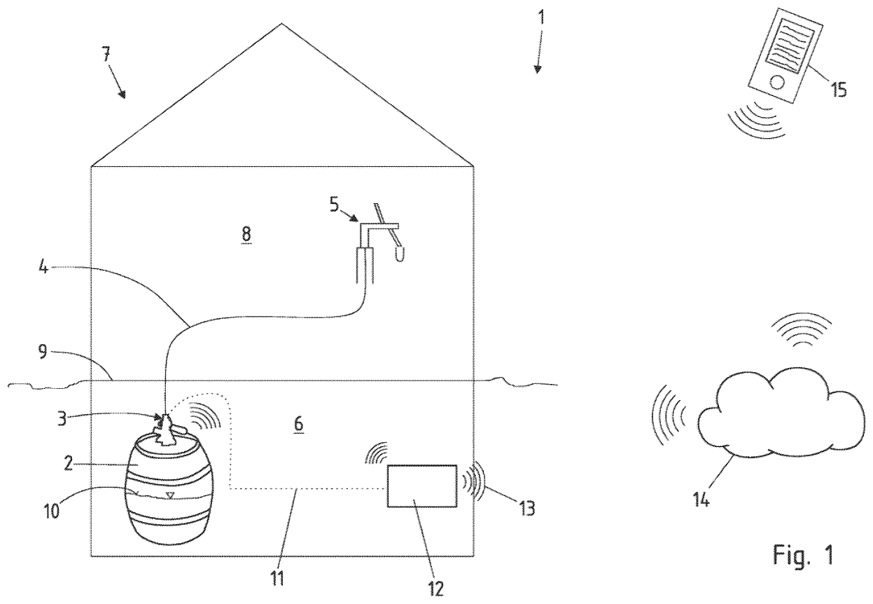

FIG. 1 shows an arrangement 1 according to the disclosure for detecting the through-flow and/or the filling state of a beverage keg 2. For this purpose, a keg coupler 3 is arranged on the keg 2 and a sensor, not shown in detail, is integrated in the keg coupler 3. The keg coupler 3 is connected to a tap 5 via a beverage line 4. As shown here, the beverage keg 2 is located in a cellar 6 of a building 7. The tap 5 is located in a dispensing room 8. The cellar 6 and the dispensing room 8 is then able to be separated from each other by a room ceiling 9. The operator of the tap 5 is able to be aware of the individual fill level 10 or the fill level 10 of the beverage keg 2 shown. Several beverage kegs 2 are able to be arranged to provide different beverages at different taps 5, but this is no longer shown here. The sensor of the keg coupler 3 is now connected to an electronic evaluation unit 12. This is able to be done wirelessly, but also by cable 11. The electronic evaluation unit 12 preferably communicates in turn by wireless signal with an external database, shown here in the form of a cloud 14. Either only raw data is transmitted so that the fill level 10 is calculated using an algorithm of a web-based program within the cloud 14. However, the calculation is also able to take place in the electronic evaluation unit 12. From there or from the cloud 14, the fill level 10 is able to be queried or displayed via a terminal 15, for example a tablet or a PDA or smartphone. This makes possible to provide the required information for the further organizational process, for example for reordering beverages or the imminent keg change. The keg change is then entered by the operator either at the unit 12 or via a terminal 15 if the equipment variant with the NFC antenna is not available and a keg is able to be read with a tag. For example, an alarm signal is also able to be provided when a keg change is imminent or when the temperature sensor on the dispensing tap 5 or the pressure sensor on the pressure reducer detects a deviation. At peak times in the dispensing room 8, all guests are able to be supplied with beverages without major downtimes.

The advantage described is that the measurement technology is able to be reduced to a minimum, so that the cleaning of the beverage line 4 and the provision of food-compatible measurement technology is also optimized.

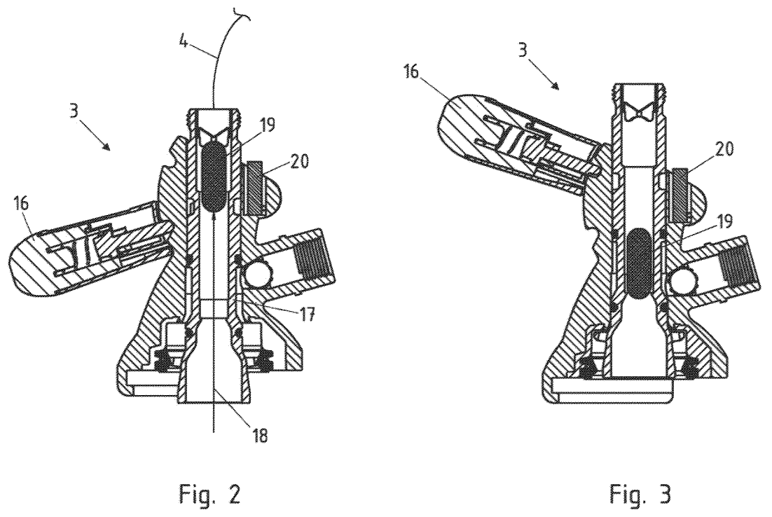

A preferred embodiment is shown in FIG. 2 and FIG. 3. A keg coupler 3 is shown here, which is shown in FIG. 2 in the attached and locked state and in FIG. 3 in the open state. The keg coupler 3 itself has a lever 16. When the lever 16 is pressed down and locked, a keg coupler plunger 17 is moved downwards in the axial direction of the figure plane into a fitting of a beverage keg 2, which is not shown in detail. The beverage is able to be guided in the direction of arrow 18 through the beverage line 4 towards the tap 5, which is not shown in detail. For this purpose, a non-return device, for example, in the form of a magnetic rod 19 or a magnetic rod 19 with a food-compatible coating, is arranged in the keg coupler plunger 17. The magnetic rod 19 is moved upwards in the axial direction, for example, due to the fluid flowing through it. A sensor 20, here in the form of a Reed sensor 20, is arranged in or on the keg coupler 3. This recognizes the position of the magnetic rod 19 and is able to therefore emit the “through-flow” sensor signal. In FIG. 3, the magnetic rod 19 is arranged downwards in relation to the vertical direction and not in the vicinity of the Reed sensor 20. The “no through-flow” signal is therefore given. Optionally, a sensor (not shown in detail), which is arranged in the region of the lever 16 or detects the lever position, is able to be used to ensure that, for example, a horizontal positioning of the keg coupler 3 and thus an inadvertent upward sliding of the magnetic rod 19 nevertheless causes the emission of the “no through-flow” signal, since in this state, for example when changing the keg, no flow of fluid occurs.

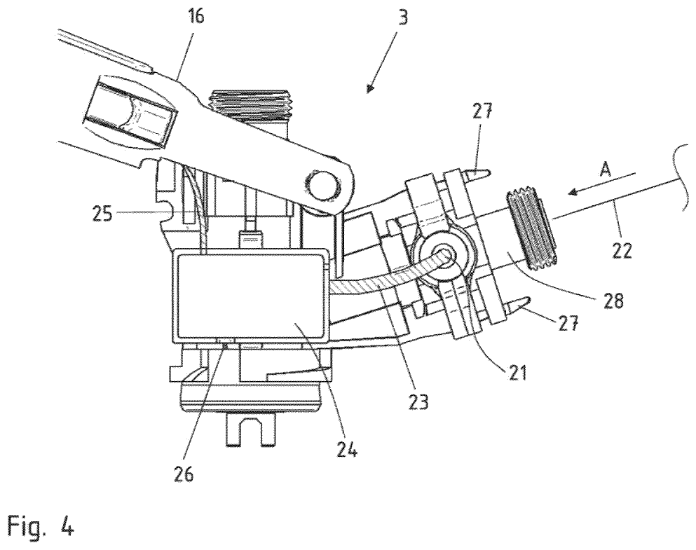

FIG. 4 shows the keg coupler with a pressure sensor 21, which is arranged in a gas line 22 or the gas tap in the keg coupler 3. The pressure sensor 21 is coupled via a cable 23 to an electronic unit 24 arranged on the keg coupler 3. Furthermore, the Reed sensor 20 is also connected to the electronic unit 24 via a connecting cable and the antenna 26, which is described further in the following figures, is also coupled to the electronic unit 24. The electronic unit 24 is able to be integrated directly into a keg coupler made of plastic material. For example, a lockable cover is able to only be clipped onto the electronics unit 24 or, for example, the electronics are molded with resin after assembly in order to protect them.

Two spring tabs 27 are also shown. The spring tabs 27 are used to attach a gas adapter 28 to the keg coupler in axial direction A. Furthermore, latching hooks 29 are arranged on the gas adapter 28 to accommodate the pressure sensor 21. A screw thread for attaching a receptacle for the pressure sensor 21 of a gas adapter 28 is able to be omitted. Easier handling is therefore possible.

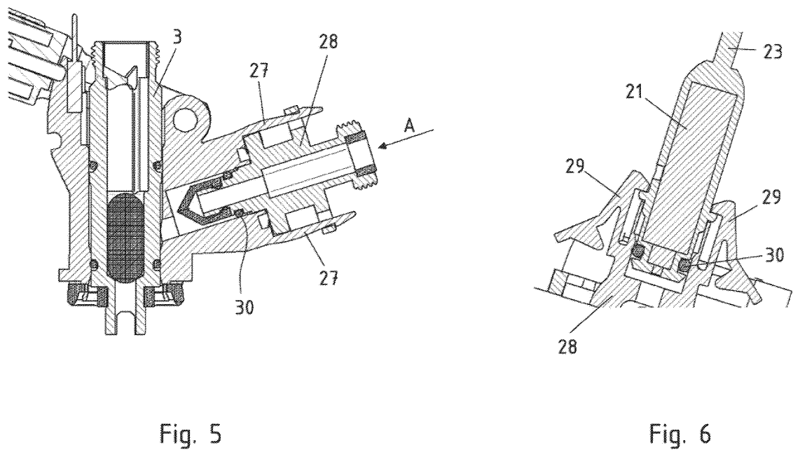

FIG. 5 and FIG. 6 show this once again. In FIG. 5, a gas adapter 28 is inserted via the spring tabs 27 on the gas side. For this purpose, the gas adapter 28 is able to simply be inserted in axial direction A and locked in place. This is then sealed gas-tight via an O-ring 30.

FIG. 6 shows a pressure sensor 21 which is inserted into the gas adapter 28. Latching hooks 28 are arranged for this purpose and the pressure sensor 21 is sealed via a further O-ring 30. The cable 23 of the pressure sensor 21 is able to therefore rotate around its own axis, so that assembly is simplified and a pressure sensor 21 would not cause a corresponding twisting of the cable due to a thread.

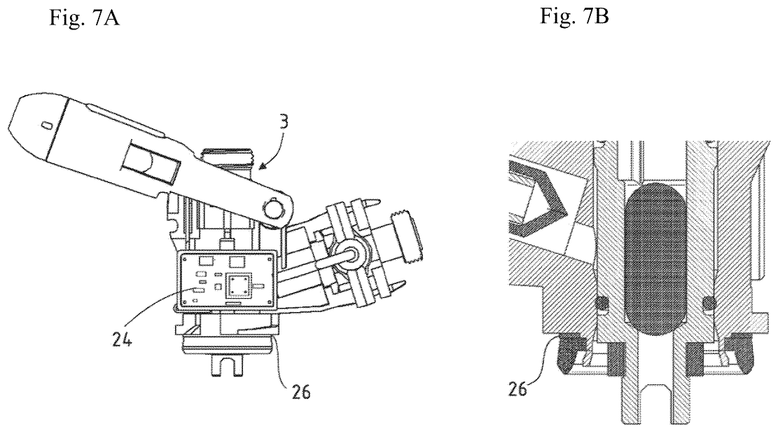

FIG. 7A and FIG. 7B show a further advantageous embodiment of the disclosure. Here, an antenna 26 is integrated in the region of an underside of the keg coupler 2. The antenna 26 is used to read out data arranged on the data carrier of a fitting or keg not shown in detail. The antenna 26 is connected to the electronic unit. This is able to be used to read out the data on the data carrier of the keg and/or the data on the data carrier of the fitting, for example the filling location, filling date, contents of the keg or keg volume and the type of beverage in the keg. FIG. 7B shows a detailed sectional view of FIG. 7a.

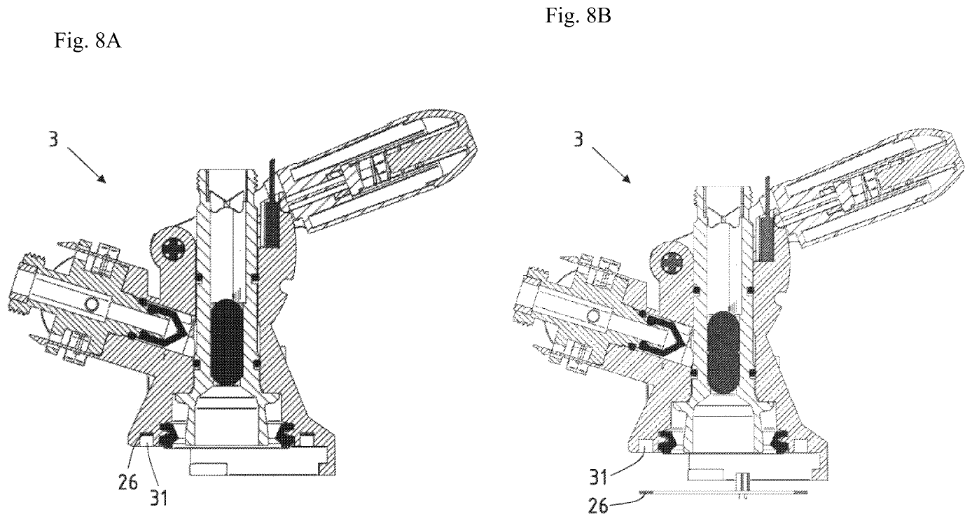

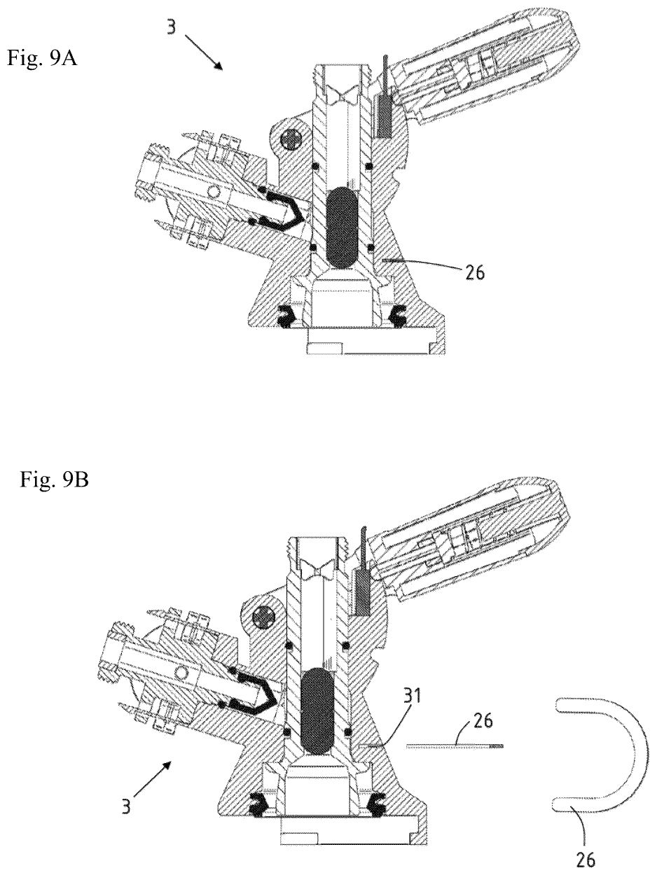

FIG. 8A and FIG. 8B show an alternative design variant. Here, for example, the antenna 26 is inserted as a circumferential half circle in a groove 31 running around the bottom of the keg coupler 3, in the case of FIG. 8A. FIG. 8B shows an exploded view.
FIG. 9A and FIG. 9B show further alternative design variants. Here, the antenna 26 is not inserted on the underside of the keg coupler 3 with respect to the vertical direction, but in a central region, as shown in FIG. 9A. FIG. 9B, which is an exploded view, shows that the antenna is pulled out of a corresponding groove and is shown in plan view. The antenna 26 is not circularly round or designed as a ring, but is U-shaped, for example, so that the antenna is able to be inserted from the side.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A keg coupler arrangement for connection to a beverage keg, the keg coupler arrangement comprising:
a keg coupler; and
in the keg coupler, at least one of
a through-flow sensor for determining a through-flow,
a pressure sensor, or
an antenna for reading out data.

12. The keg coupler arrangement according to claim 11, wherein the antenna is an NFC antenna configured to read out data from a memory of a fitting of the beverage keg.

13. The keg coupler arrangement according to claim 11, wherein the pressure sensor is in a gas line or beverage line of the keg coupler.

14. The keg coupler arrangement according to claim 11, further comprising:
an electronic unit which is arranged directly on the keg coupler.

15. The keg coupler arrangement according to claim 11, wherein the through-flow sensor is a Reed sensor.

16. The keg coupler arrangement according to claim 15, further comprising:
a non-return valve element arranged in the keg coupler, the non-return valve element comprising a magnetic rod configured to activate the Reed sensor.

17. The keg coupler arrangement according to claim 11, wherein the pressure sensor is inserted into the keg coupler.

18. The keg coupler arrangement according to claim 11, wherein the through-flow sensor comprises two pressure sensors arranged in series one behind the other.

19. The keg coupler arrangement according to claim 11, further comprising:
a gas adapter connected directly to the keg coupler.

20. The keg coupler arrangement according to claim 11, wherein the keg coupler is at least partially made of a plastic material.

21. The keg coupler arrangement according to claim 11, wherein the antenna is an RFID antenna.

22. The keg coupler arrangement according to claim 11, wherein the through-flow sensor is a capacitive sensor.

23. The keg coupler arrangement according to claim 11, wherein the through-flow sensor is an inductive sensor.

24. The keg coupler arrangement according to claim 16, wherein the magnetic rod is a food-compatible encased magnet.

25. The keg coupler arrangement according to claim 11, wherein the pressure sensor is inserted into the keg coupler by latching hooks.

26. The keg coupler arrangement according to claim 19, wherein the gas adapter is connected directly to the keg coupler by a plug connection.
